(19) United States
(12) Patent Application Publication
(10) Pub. No.: US 2006/0272195 A1
(43) Pub. Date: Dec. 7, 2006

(54) BAIT NEEDLE AND METHOD OF BAITING

(76) Inventor: KERRY B. EKKER, Richfield, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/421,633

(22) Filed: Jun. 1, 2006

Related U.S. Application Data
(60) Provisional application No. 60/686,572, filed on Jun. 2, 2005.

(51) Int. Cl. A01K 97/00; A01K 83/06

(52) U.S. Cl. 43/4; 43/44.2

(57) ABSTRACT

A bait needle is formed from an elongate rod having a first end portion and a second end portion, the first end portion defines a pointed end and the second end portion has flattened sides. The second end portion defines an eye transversely extending through the second end there through and a slot. The slot is angled with the opening of the slot closer to the pointed end than the bottom of the slot. The opening of the slot also has a leading edge that has a height greater than a height of the trailing edge. A method of using the bait needle is also provided.

### CROSS-REFERENCE TO RELATED APPLICATIONS

The present invention claims priority to co-pending U.S. Provisional Patent Application Ser. No. 60/686,572 filed on Jun. 2, 2005, which is herein incorporated by this reference.

### BACKGROUND OF THE INVENTION

1. Field of the Invention

The present invention relates generally to a bait needle, and more specifically to a bait needle that allows a user to place a hook at any desired location in bait fish, night crawlers, all soft rubber or plastic baits and any other such baits known in the art without any exposed line.

2. State of the Art

While many fishermen prefer live bait to artificial lures, various artificial baits have been developed over the years that simulate the look of live bait. In both cases, it is desirable to be able to bait a hook, whether using live bait or artificial bait in a manner that is easy to perform and that does not destroy the bait in the process. In addition, there is a need in the art to provide a means for baiting real or artificial bait that allows for desired placement of a hook for increasing the potential for catching a fish that is attracted to the bait.

Various devices have been suggested in the art to address the foregoing needs. For example, in U.S. Pat. No. 4,559,734, a tool is inserted at an entrance point near one end of a bait and pushed through the bait until it exits near the other end of the bait. An end of leader opposite the fish hook is attached to the tool, and the tool is withdrawn from the bait, which pulls the leader through the bait with the hook near the exit point and the end of the leader opposite the hook, through the entrance point where it can be connected to fishing line. In U.S. Pat. No. 4,977,699, an open eye awl is used to thread a fishing line leader and straight shank portion of a hook into the bait instead of inserting the barbed point end of the fishing hook. Similarly, baiting devices are disclosed in U.S. Pat. Nos. 5,016,383, 3,925,919 and 4,706,403. Due to their construction, however, each of the foregoing prior art devices have the potential of damaging the bait when inserted and/or retracted and are limited in the manner in which a leader or leadered hook can be attached to the bait.

### SUMMARY OF THE INVENTION

Accordingly, a bait needle, in accordance with the principles of the represent invention, is formed from an elongate rod having a first end portion and a second end portion. The first end portion defines a pointed end and the second end portion has flattened sides. The second end portion defines an eye transversely extending through the second end there through and a slot. The slot is angled with the opening of the slot closer to the pointed end than the bottom of the slot. The opening of the slot also has a leading edge that has a height greater than a height of the trailing edge.

In one embodiment of the bait needle, the slot is angled at approximately 45 degrees.

In another embodiment of the bait needle, the elongate rod that forms the bait needle is formed from one of the group comprising stainless steel, brass, copper, chromed steel, copper plated steel, brass plated steel and plastic.

In yet another embodiment of the bait needle, the second end potion is tapered toward the first end portion.

In still another embodiment of the bait needle, a front of the slot has a depth of approximately 5/32 inch and a rear of the slot has a depth of approximately ⅛ inch.

The present invention also includes a method of baiting a fishing line by first employing a bait needle according to the principles of the present invention and then using the bait needle to perform certain novel baiting techniques.

In one embodiment of a method according to the principles of the present invention, the elongate rod is inserted into a bait at a desired hook location, a loop of a leadered hook is inserted into the slot, the elongate rod is passed through the bait along a path until the bait needle exits the bait, and the loop of the leadered hook is pulled through the bait until the hook resides at the desired hook location.

In another embodiment, the desired hook location is along the body of the bait.

In yet another embodiment, the needle exits the bait proximate a mouth of the bait.

In still another embodiment, a fishing line is inserted into a bait by inserting the elongate rod into a bait at a desired exit location, inserting a fishing line through the eye of the elongate rod, passing the elongate rod through the bait along a path until the bait needle exits the bait at a desired hook location, and attaching a hook to the fishing line at the desired hook location.

The method of the present invention may also include attaching more than one hook to the fishing line with each hook at a different location on the bait.

10. Such a method may include inserting the elongate rod into the front of the bait, forcing the elongate rod along a first path and exiting the elongate rod at a first desired hook location, removing the elongate rod from the fishing line, attaching a hook to the fishing line, inserting the fishing line into the eye, reinserting the elongate rod into the bate proximate the first desired hook location, forcing the elongate rod along a second path and exiting the elongate rod at a second desired hook location, and attaching a hook to said fishing line proximate said second desired hook location.

The foregoing advantages and characterizing features will become apparent from the following description of certain illustrative embodiments of the invention. The above-described features and advantages of the present invention, as well as additional features and advantages, will be set forth or will become more fully apparent in the detailed description that follows and in the appended claims. The novel features which are considered characteristic of this invention are set forth in the attached claims. Furthermore, the features and advantages of the present invention may be learned by the practice of the invention, or will be obvious to one skilled in the art from the description, as set forth hereinafter.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a perspective side view of a first embodiment of a bait needle in accordance with the principles of the present invention.

FIG. 2 is a partial side view of the bait needle illustrated in FIG. 1.

FIG. 3 is an end view of the bait needle illustrated in FIGS. 1 and 2.

FIG. 4 is a side view of a first technique for using a bait needle in accordance with the principles of the present invention.

FIG. 5 is a side view of a second technique for using a bait needle in accordance with the principles of the present invention.

FIG. 6 is a side view of a third technique for using a bait needle in accordance with the principles of the present invention.

### DETAILED DESCRIPTION OF THE ILLUSTRATED EMBODIMENTS

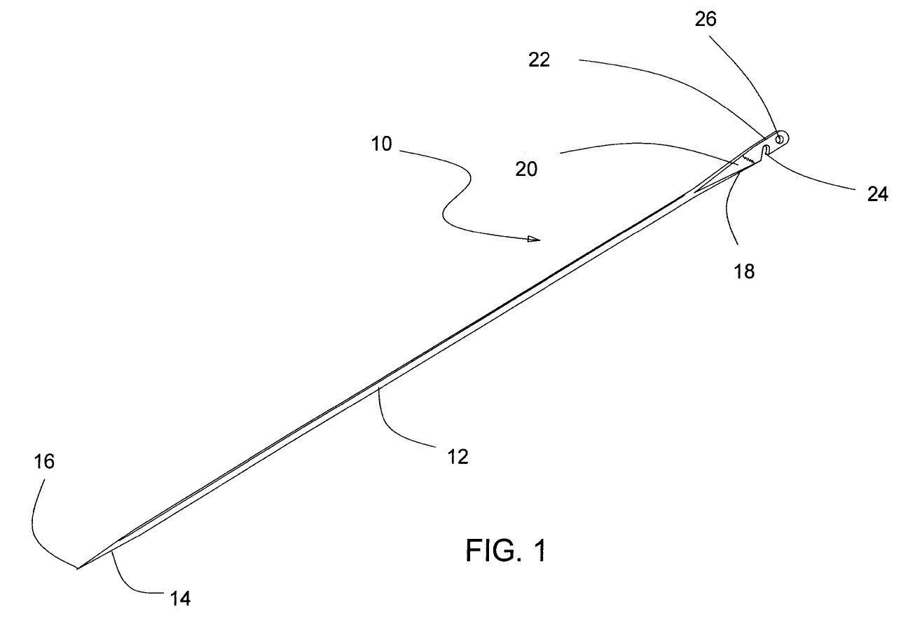

As shown in FIG. 1, a bait needle 10 is comprised of an elongate needle 12 having a first end 14 that comes to a pointed end 16 and a second end 18 that is flattened along the sides 20 and 22 thereof. The pointed end 16 may be in the form of a one inch taper. The flattened portion of the second end 18 may be approximately ⅝ inch. In addition the height of the flattened portion may be approximately 5/32 inch with a thickness of approximately 1/32 inch. The second end 18 defines an angled slot 24 and a transversely extending aperture 26 or eye. The slot may be at a 45 degree angle to the longitudinal axis of the needle 12. The slot has a length of approximately ⅛ inch with a slot width equal to the thickness of the flattened portion of the second end 18. The aperture 26 has a diameter of approximately 1/16 inch. The bait needle 10 may be formed from stainless steel, brass, copper, chromed steel, copper plated steel, brass plated steel and special plastics or any other appropriate material known in the art.

As will be described in more detail, the slot 24 and the aperture 26 can be used to thread fishing line through the bait. In the case of hooks with leader, the loop end of the fishing line can be placed in the slot 24 and pulled through the bait by driving the bait needle through the bait, pulling the fishing line through the bait.

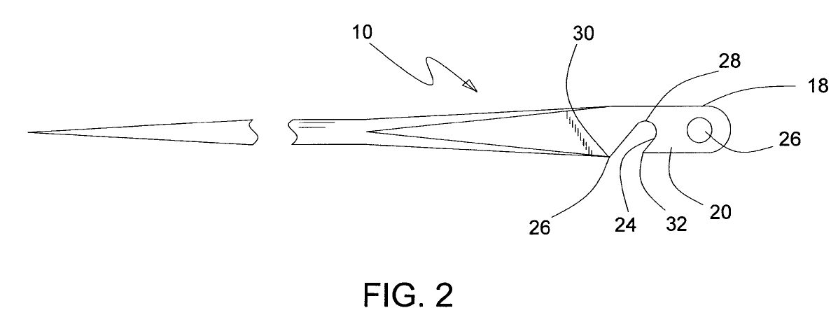

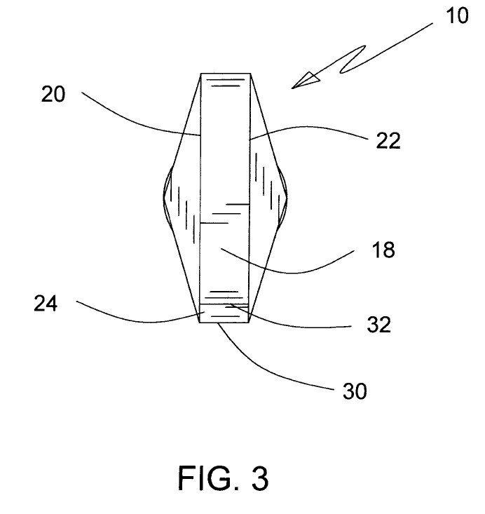

As shown in FIGS. 2 and 3, the second end 18 of the bait needle 10 is flattened along its sides 20 and 22 and has a generally tapered configuration when viewed as shown in FIG. 2. The second end 18 forms a blade having a taper of approximately 3/32 inch to 1/32 inch. The slot 24 that is formed in the second end is angled in a direction such that the opening 26 of the slot 24 leads or is closer to the pointed end 16 than the base 28 of the slot 24. As such, a loop in a fishing line can be pulled by the slot through a bait. For a length of fishing line, the fishing line can be threaded through the aperture 26 and pulled through the bait in a similar fashion.

In order to prevent the slot from catching on and tearing the bait when pulling the bait needle 10 through a bait, the leading edge 30 of the slot 24 is taller than the trailing edge 32. That is, the distance from the longitudinal axis of the bait needle to the leading edge 30 is greater than the distance from the longitudinal axis of the bait needle to the trailing edge 32 of the slot 24. The front of the slot 24 has a depth of approximately 5/32 inch while the rear of the slot has a depth of approximately ⅛ inch. As such, the wedge formed at the trailing edge 32, while holding a loop of a leader, will simply follow the leading edge 30 of the slot 24 with little, if any, damage to the bait. That is, as the trailing edge 32 will tend to follow the leading edge 30 and, thus, not tend to tear the bait as it is pulled through the bait.

The bait needle 10 of the present invention allows one to place a hook in a bait without distorting the natural form of the bait to maintain the realistic appearance of the bait. In addition, the bait needle 10 of the present invention allows a user to place a hook at virtually any desired location to help increase the chances of making a catch by proper hook placement. Furthermore, the bait needle 10 of the present invention decreases bait loss by allowing for secure attachment of the bait to the fishing line and hook. Moreover, it is possible with the present invention to string together various baits such as adding other attractions to the main bait like marshmallows, fish eggs, and the like.

The bait needle 10 can be used with all types of hooks including, without limitation, bait hooks, worm hoods, offset shank hooks, and treble hooks. The hook can be attached without any exposed line between the hook and the exterior of the bait, providing for significantly stronger attachment. The bait needle 10 can also be used with all types of bait including, without limitation, night crawlers, soft plastic baits, bait fish, minnows and the like.

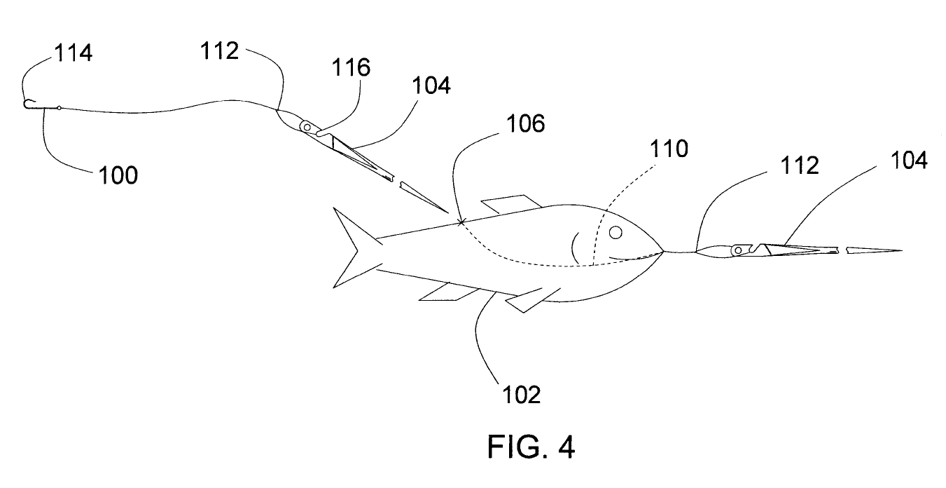

Referring now to FIG. 4, there is shown a method of baiting a leadered hook, 100 with a minnow 102. The bait needle 104 of the present invention is inserted into the minnow 102 at the desired hook location 106. The bait needle 104 is passed through the minnow 102 along the path 110 until the bait needle 104 exits the bait 102 pulling the loop 112 of the leadered hook 100 through the bait 102. The loop 112 is pulled until the hook 114 resides at the desired hook location 106. Thus, one simply insert the point of the bait needle 104 at the desired location of the hook, pushes the point of the needle through the center of the bait and exits the point of the needle at the desired location, such as the front of the bait. The loop of the hook leader is placed in the slot 116 and, since the slot is angled toward the front or pointed end of the needle, is pulled through the bait.

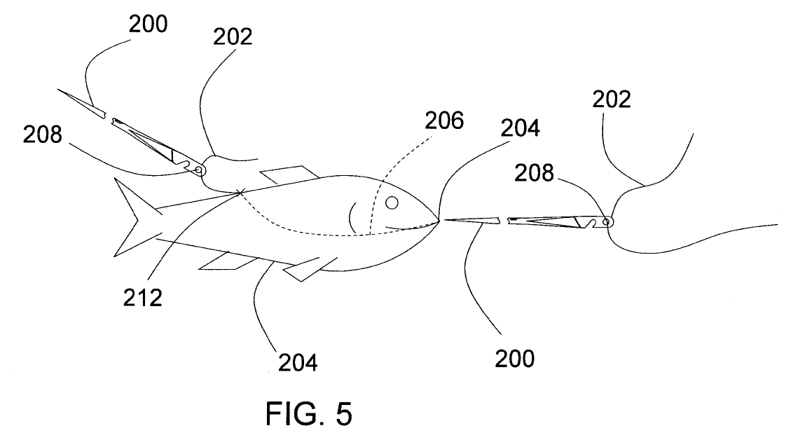

As shown in FIG. 5, the bait needle 200 of the present invention may be employed to thread a line 202 through a bait 204 along path 206. To do so, the line 202 is threaded through the eye 208 of the bait needle. The needle 200 is inserted through the bait starting with the exit point 210, along the path 206 and exiting at the desired hook location 212. As such, the needle 200 can be employed to pull the line 202 through the bait, exiting at the desired hook location. A hook can then be tied to the line 202 at the desired hook location 212.

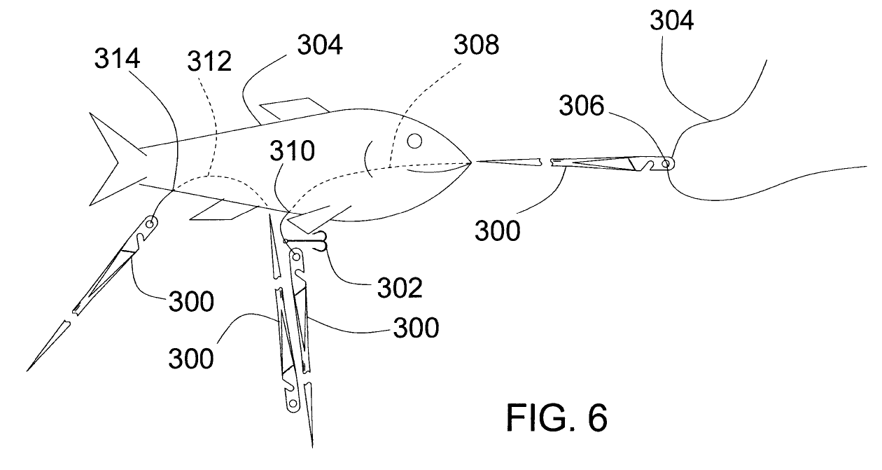

As shown in FIG. 6, the bait needle 300 of the present invention can be employed to place more than one hook 302, each in a different location on the bait 304. The needle 300 is inserted with line 304 through the needle eye 306 into the front of the bait. The needle 300 is forced along a first path 308 to exit a first desired hook location 310. The needle 300 is removed from the line 304 and a hook 302 is placed on the line. The line 304 is then reinserted into the eye 306 and the needle 300 is reinserted into the bait 304 a location proximate the first exit point 310. The needle 300 is guided along a second path 312 to exit at a second desired hook location 314. At the second location, a hook is tied to the line 304. Accordingly, the bait 304 is provided with two hooks attached to the same line 304. Various knots known in the art can be used to tie the hooks to the line.

It should be noted that the bait needle of the present invention has a length that is greater than the bait. As such, the needle can be inserted into the bait until the leading point or tip protrudes from the other side of the bait. The leading end of the needle can then be grasped to pull the leader through the bait. In one embodiment, the needle is formed from 3/32 inch round stock of 309 stainless steel, but could be formed or round, square or other geometric shaped rods having a diameter of between about 1/32 inch through about 1.2 inch. In addition, the needle may be formed from solid brass, copper, chromed steel, copper plated steel, brass plated steel or special types of plastics or other materials known in the art. The length of the needle is approximately 10 inches, but could have a length of between about 6 inches to 12 inches, depending on the size of the bait. The trailing end of the needle has a ⅝ inch long tapered rear blade portion flattened to 5/32 inch width and 1/32 inch thickness. The slot in the blade portion is cut at approximately a 45 degree angle relative to the longitudinal axis of the needle but may work at any angle between about 10 degrees and 80 degrees. The slot is cut with a length of approximately 3/16 inch with a width of approximately 1/32 inch. The eye hole in the blade portion has a diameter of approximately 1/16 inch. The leading edge of the slot has a blade width of approximately 5/32 inch and a trailing edge blade width of approximately ⅛ inch.

The bait needle of the present invention provides the ability to strategically place hooks in bait, fish, night crawlers, soft plastic baits and other bait with little damage to the bait. In addition, the bait is secured to the hook without exposed line for decrease bait loss and without altering the bait from its natural form.

The length of the bait need is of a length of approximately ten inches to provide for better control when using than shorter lengths and to accommodate all sizes of bait fish, soft plastic baits and night crawlers. Also, the length allows for larger baits such as those used in off shore fishing. As such, the pointed end of the needle can be completely penetrated through the bait before attachment of the fishing line.

The bait needle may be produced in various diameters such as 3/32 inch and 1/16 inch. The smaller diameter needle is easier to use when threading small baits or small soft plastics.

The needles may be made in various materials such as stainless steel or solid brass to resist corrosion. In addition, the tapered point is of sufficient length (e.g., one inch on a ten inch needle) and of a sharpness that provides ease of penetration and less bait damage due to the gradual taper.

The blade portion of the needle allows for a deeper cut slot which better secures the leader loop and also accommodates the threading of heavy line without the use of the eye. The blade increases in height from 3/32 (the diameter of the needle) to 5/32 inch and decreases in width from 3/32 to 1/32 inch. This taper is approximately ⅝ inch in length. Because bait fish have an internal cavity that is taller than wide, the decreased width of the blade accommodated the adding of the leader loop without bait damage. The blade peaks in height just in front of the slot and is ground to ⅛ inch height just behind the slot. This eliminates a hook or snag that would otherwise damage the bait.

The slot is notched into the blade at approximately a 45 degree angle with a ⅛ inch depth and 1/32 inch width. The 45 degree angle provides security and alignment for the penetration of the leader loop. The ⅛ inch depth provides security for leader loop and the 1/32 inch width provides ease of installation and removal of the leader. The slot will also accommodate the threading of heavy lines without the use of the eye.

The eye is drilled with a 1/16 inch diameter and is for threading line through the bait. The 1/16 inch diameter allows for the threading of most sizes of lines.

It is understood that the terminology used herein is used for the purpose of describing particular embodiments only and is not intended to limit the scope of the present invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods, compositions, and materials of the present invention are described herein, any methods and materials similar or equivalent to those described herein may be used in the practice or testing of the present invention. All references cited herein are incorporated by reference in their entirety and for all purposes.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A bait needle, comprising:
an elongate rod having a first end portion and a second end portion;
said first end portion defining a pointed end and the second end portion having flattened sides;
said second end portion defining an eye transversely extending there through and a slot, said slot being angled from an opening to a bottom of the slot with the opening of the slot being closer to the pointed end than the bottom of the slot; and
said opening of said slot having a leading edge and a trailing edge, said leading edge having a height that is greater than a height of said trailing edge.

2. The bait needle of claim 1, wherein said slot is angled at approximately 45 degrees.

3. The bait needle of claim 1, wherein said elongate rod may be formed from one of the group comprising stainless steel, brass, copper, chromed steel, copper plated steel, brass plated steel and plastic.

4. The bait needle of claim 1, wherein said second end potion is tapered toward said first end portion.

5. The bait needle of claim 1, wherein a front of said slot has a depth of approximately 5/32 inch and a rear of said slot has a depth of approximately ⅛ inch.

6. A method of baiting a fishing line, comprising;
providing an elongate rod having a first end portion and a second end portion, said first end portion defining a pointed end and the second end portion having flattened sides, said second end portion defining an eye transversely extending there through and a slot, said slot being angled from an opening to a bottom of the slot with the opening of the slot being closer to the pointed end than the bottom of the slot, and said opening of said slot having a leading edge and a trailing edge, said leading edge having a height that is greater than a height of said trailing edge;
inserting the elongate rod into a bait at a desired hook location;
inserting a loop of a leadered hook into the slot;
passing the elongate rod through the bait along a path until the bait needle exits the bait; and
pulling the loop of the leadered hook through the bait until the hook resides at the desired hook location.

7. The method of claim 6, wherein said desired hook location is along the body of the bait.

8. The method of claim 6, wherein the needle exits the bait proximate a mouth of the bait.

9. A method of baiting a fishing line, comprising;
providing an elongate rod having a first end portion and a second end portion, said first end portion defining a pointed end and the second end portion having flattened sides, said second end portion defining an eye transversely extending there through and a slot, said slot being angled from an opening to a bottom of the slot with the opening of the slot being closer to the pointed end than the bottom of the slot, and said opening of said slot having a leading edge and a trailing edge, said leading edge having a height that is greater than a height of said trailing edge;
inserting the elongate rod into a bait at a desired exit location;
inserting a fishing line through the eye of the elongate rod;
passing the elongate rod through the bait along a path until the bait needle exits the bait at a desired hook location; and
attaching a hook to the fishing line at the desired hook location.

11. The method of claim 9, further comprising attaching more than one hook to the fishing line, each hook at a different location on the bait.

12. The method of claim 10, first comprising inserting the elongate rod into the front of the bait, forcing the elongate rod along a first path and exiting said elongate rod at a first desired hook location, removing the elongate rod from the fishing line, attaching a hook to the fishing line, inserting the fishing line into the eye, reinserting the elongate rod into the bate proximate the first desired hook location, forcing the elongate rod along a second path and exiting said elongate rod at a second desired hook location, and attaching a hook to said fishing line proximate said second desired hook location.
